(19) United States
(12) Patent Application Publication
(10) Pub. No.: US 2019/0041296 A1
(43) Pub. Date: Feb. 7, 2019

(54) CRACKED AXLE DETECTION

(71) Applicant: Gerard Carroll, Boulder, CO (US)

(72) Inventor: Gerard Carroll, Boulder, CO (US)

(21) Appl. No.: 15/937,351

(22) Filed: Mar. 27, 2018

Related U.S. Application Data
(60) Provisional application No. 62/541,009, filed on Aug. 3, 2017.

(51) Int. Cl. G01M 17/10; G01N 29/12

(52) U.S. Cl. CPC G01M 17/10; G01N 29/12

(57) ABSTRACT

A method for railcar axle crack detection takes advantage of crack breathing. The method includes exciting resonance frequencies of a railcar axle, measuring the resonance frequencies of the railcar axle, selecting at least one resonance frequency from the measured resonance frequencies and automatically determining whether the railcar axle is cracked from the at least one selected resonance frequency. An associated system includes means for exciting resonance frequencies of a railcar axle, means for measuring the resonance frequencies of the railcar axle and computing hardware. The computing hardware is configured to select at least one resonance frequency from the measured resonance frequencies and automatically determine whether the railcar axle is cracked from the at least one identified resonance frequency.

### CROSS REFERENCE TO RELATED APPLICATIONS

This application claims the priority benefit of U.S. Provisional Application No. 62/541,009 filed on Aug. 3, 2017 which is incorporated herein by reference in its entirety.

### SUMMARY

The present disclosure seeks to provide a method for railcar axle crack detection, including exciting resonance frequencies of a railcar axle, measuring the resonance frequencies of the railcar axle, selecting at least one resonance frequency from the measured resonance frequencies and automatically determining whether the railcar axle is cracked from the at least one selected resonance frequency.

The present disclosure also seeks to provide a system for railcar axle crack detection, including means for exciting resonance frequencies of a railcar axle, means for measuring the resonance frequencies of the railcar axle and computing hardware. The computing hardware is configured to select at least one resonance frequency from the measured resonance frequencies and automatically determine whether the railcar axle is cracked from the at least one identified resonance frequency.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those having ordinary skill in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a graph showing the spectral response of a railcar axle for the 0 to 100 kHz frequency range.

FIG. 2 illustrates a graph showing the spectral response of the railcar axle of FIG. 1 for the 30 to 35 kHz frequency range.

FIG. 3 illustrates a flow of an example method for railcar axle crack detection.

FIGS. 4A-4D illustrate an example measurement of vibration response for both axles of a two-axle bogie for a moving train.

FIG. 5 illustrates an example axle impact response time history measured using an accelerometer attached to an axle.

FIG. 6 illustrates an example of the area in contact between crack surfaces as a function of axle rotation for a 35% cracked axle cross section.

FIG. 7 illustrates uncompressed impact time history, time compression factor for three initial conditions, and measurement time window for 20 mph train.

FIG. 8 illustrates a spectral response of (a) uncompressed time history, and (b) compressed time history for three initial conditions, for 20 mph train

FIG. 9 illustrates uncompressed impact time history, time compression factor for three initial conditions, and measurement time window for 40 mph train.

FIG. 10 illustrates a spectral response of (a) uncompressed time history, and (b) compressed time history for three initial conditions, for 40 mph train

FIGS. 11 A & B illustrate time history for accelerometer response measured on track and impact response measured on axle (a) and spectral response for accelerometer measured on track and impact response measured on axle (b), all for 5 mph train

FIGS. 12 A & B illustrate time history for accelerometer response measured on track and impact response measured on axle (a) and spectral response for accelerometer measured on track and impact response measured on axle (b), all for 10 mph train.

FIG. 13 illustrates a flow of another example method for railcar axle crack detection.

FIGS. 14A-140 illustrate various positions of a railcar axle during an example semi-static method for railcar axle crack detection.

FIG. 15 illustrates spectral response simulation results for train stopped with axle crack at bottom of axle (crack open) and axle crack at top of axle (crack closed).

FIGS. 16A-C illustrate an example impact hammer in use to impact a wheelset axle as a train traverses a measurement location.

FIG. 17 illustrates an example projectile impact mechanism and an example collocated laser Doppler vibrometer measurement system.

FIG. 18 illustrates an example computing device suitable for use with disclosed systems and methods for cracked axle detection.

### DETAILED DESCRIPTION

The following detailed description illustrates embodiments of the present disclosure and manners by which they can be implemented. Although the best mode of carrying out the present disclosure has been disclosed, those having ordinary skill in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

The present disclosure addresses condition-based monitoring of railway equipment. More particularly, the disclosure is in the field of wayside detection of rolling stock defects.

Railroad wayside detectors monitor passing trains and alert rail car owners to potential defects enabling them to schedule appropriate maintenance in a safe, timely and cost-effective manner. Example wayside systems include 1) Acoustic Bearing Detectors, 2) Railway Bearing Acoustic Monitors, 3) Truck Bogie Optical Geometry Inspection, 4) Truck Performance Detectors, 5) Wheel Impact Load Detectors, 6) Wheel Profile Measurement Systems, and, 7) Hot Box and Dragging Equipment Detectors. However, there remains a need for wayside cracked axle detection.

Currently, rail axle inspection can only be carried out in depot or at overhaul. Methods used include ultrasonics, magnetic particle inspection (MPI), eddy current methods, AC field measurement (ACFM) and electro-magnetic array (EMA) methods. All these methods require a level of accessibility to the axles (removing wheels from axle, removing trucks from railcar, stationary wheelset) which is not be possible for a moving railcar and therefore cannot be extended to a wayside system.

A previous attempt at developing a wayside cracked axle is based on using ultrasonic laser pulse excitation and air coupled transducers response measurements. This technology (LAHUT, Laser Air Hybrid Technology) was developed at Johns Hopkins University Center for Non-Destructive Evaluation and evaluated for cracked axle applications at Transportation Technology Center Inc., TTCI. The technique employs the fact that a crack between the excitation and response location will modify the response time history indicating a possible flaw.

For a single excitation and response measured along a line in the axial dimension, a defect within about +/−10 degrees of the line can be detected. This requires the excitation/response measurement be repeated approximately ten times around the moving axle circumference to provide full axle inspection coverage.

More recently an AC thermography based wayside cracked axle detector was investigated in the UK. This effort was aimed at extending AC thermography to wayside systems by developing methods for introducing substantial electricity into the axle and measuring, on the exposed section of the axle, the heat patterns due to the propagation of electric current past a crack.

Another method proposed for structural health monitoring makes use of the crack breathing phenomenon to detect cracked axles. This implementation has been demonstrated using a dynamic test bench and laser distance meters to measure the axle bending displacements near the center of the axle. As a crack develops, polar plots of the axle displacement become non-axisymmetric due to the once per revolution opening and closing of the crack (crack breathing). A Fast Fourier Transform (FFT) of the data shows a large increase of the lower order rotational harmonics. A stated shortcoming of this approach is that the axle has to be in the advanced stages (crack area on the order of 16%) before the increase in rotational harmonics is evident. Furthermore, since the rotational harmonics are typically below 100 Hz, rolling noise complicates measurement.

Disclosed is a method for detecting cracks in railcar axles on a train using resonance frequency shifts. Wheelset axles possess many separate and distinct resonance peaks which shift down in frequency due to the crack induced axle stiffness change. For axles on a train, the combination of wheel rotation and static load causes axle cracks to open and close once per revolution thereby causing the axle resonance frequencies to also shift once per revolution. The present disclosure provides means for both impacting and measuring the vibration response of axles on moving or semi-static railcars thereby providing the means of determining if these resonance frequencies are shifting, indicating a crack is present, or are unchanged, indicating no crack is present, once per axle revolution.

Embodiments of the present disclosure substantially eliminate, or at least partially address, problems in the prior art, enabling convenient and effective wayside crack detection in railcar axles.

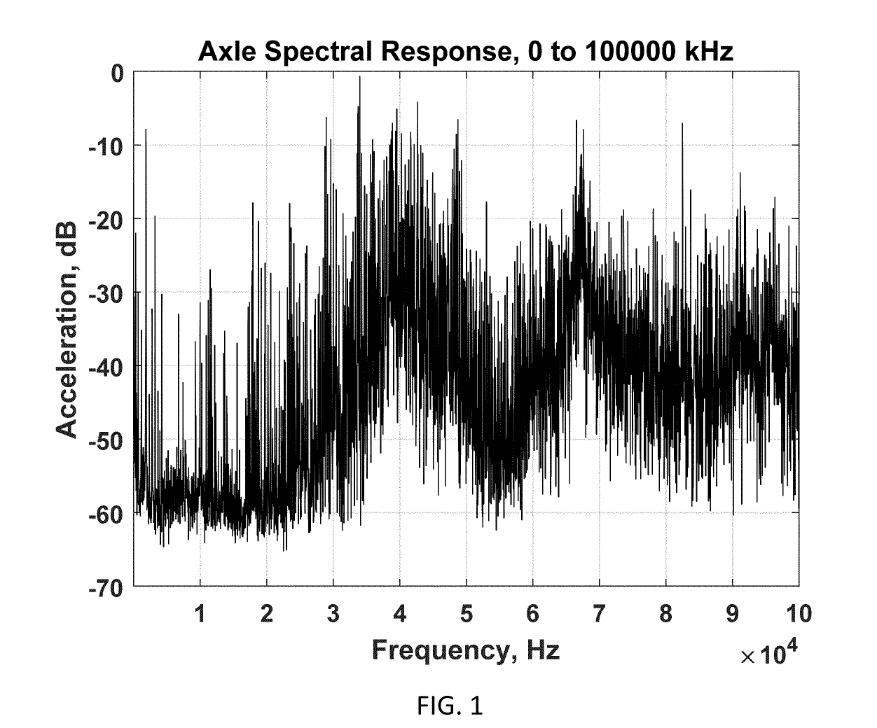

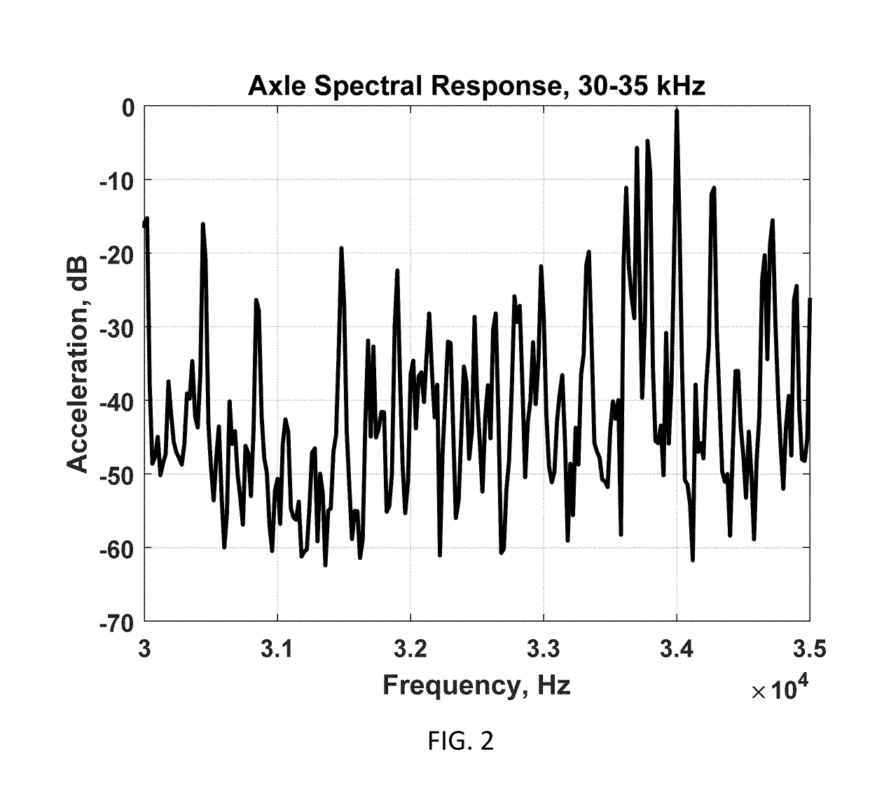

The present disclosure sets forth a method for detecting cracks in axles installed on moving or semi-static railcars using resonance frequency shifts. Rail wheelset axles possess many separate and distinct resonance peaks at frequencies up to at least 150 kHz which can be excited by impacting the axle. Examples of these resonances are shown in FIG. 1 and FIG. 2. FIG. 1 illustrates a graph showing the spectral response of a railcar axle for the 0 to 100 kHz frequency range. The axle is stationary and is impacted using a hand-held impact hammer. The response is measured using an accelerometer attached to the axle. FIG. 2 illustrates a graph showing the spectral response of the railcar axle of FIG. 1 for the 30 to 35 kHz frequency range.

The resonances of FIGS. 1 & 2 will shift due to an axle stiffness decrease caused by a crack. The resonance frequencies are determined by stiffness of the axle material and the axle mass and are expressed mathematically as:

F=\sqrt{(k/m)}

Where F is the resonance frequency, k is the axle stiffness and m is the axle mass.

It is clear from this equation that a change in stiffness will result in a corresponding shift in resonance frequency. In an example, a cracked axle may exhibit a 0.2% frequency shift across the entire frequency range compared with an uncracked axle. Normal wheelset axle geometric production variations are such that resonance frequencies vary from one axle to the next.

While shifts in resonance frequency between different railcar axles due to production variations prevents detecting frequency shifts caused by defects for an individual rail car axle without having a sample of resonance frequencies from that axle in its undamaged state, disclosed systems and methods overcome this defect detection deficit, enabling measurement of axle impact response on axles installed on moving or semi-static railcars. The combination of static loading provided by the railcar weight, and axle rotation for axles installed on moving or semi-static railcars causes axle cracks to open and close once per revolution thereby causing the axle resonances frequencies to also shift once per revolution. This phenomenon is known as crack breathing. Disclosed systems and methods take advantage of this phenomenon.

Additional aspects, advantages, features and objects of the present disclosure will be made apparent from the drawings and the detailed description of the illustrative embodiments construed in conjunction with the appended claims that follow. It will be appreciated that features of the present disclosure are susceptible to being combined in various combinations without departing from the scope of the present disclosure as defined by the appended claims.

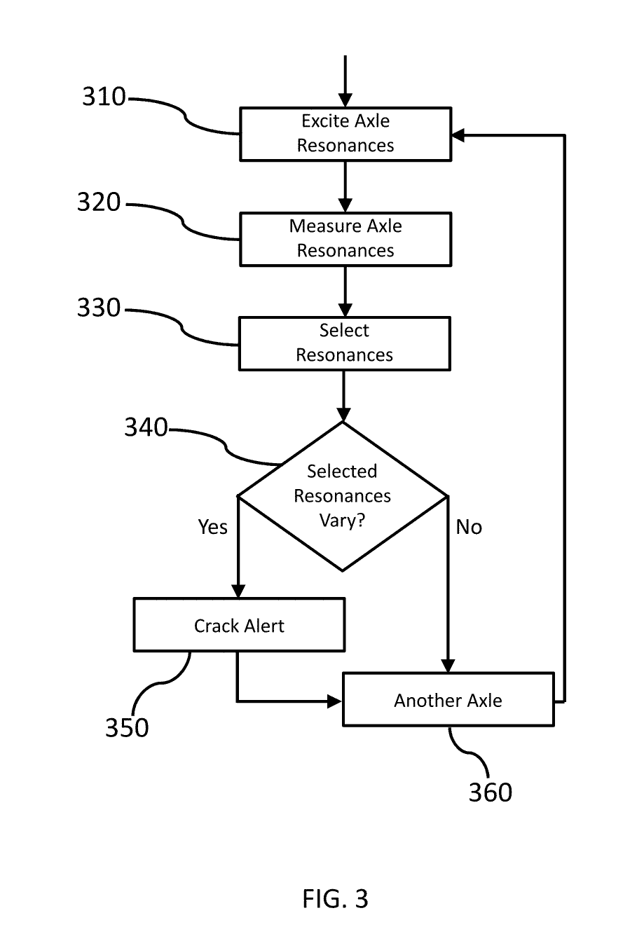

FIG. 3 illustrates a flow of an example method for railcar axle crack detection. The method is depicted as a collection of actions in a logical flow diagram, which represents a sequence of actions that may be implemented in hardware, software, or a combination thereof. In an example moving train mode, axle resonant frequencies are measured as a continually moving train passes an inspection station. As a moving train passes, an impact mechanism will impact each axle exciting the axle resonance frequencies.

The method for railcar axle crack detection and crack breathing detection includes, while the train is moving forward such that the railcar axle is rotating and translating, exciting resonance frequencies of a railcar axle at 310; measuring the resonance frequencies of the railcar axle at 320; selecting at least one resonance frequency from the measured resonance frequencies at 330; and automatically determining at 340 whether the railcar axle is cracked from the at least one selected resonance frequency. If the selected resonances vary as the railcar axle rotates, the axle may be considered cracked and a notification or alert issued at 350. Once it has been determined at 340 whether or not the railcar axle is cracked, examination may be directed to another axle at 360 beginning with another excitation. In an example, exciting and measuring resonance frequencies may take place on a following axle before a determination has been made about the preceding axle. In cases where time required to process collected data and make a determination about the existence of a crack exceeds the time available before measuring another axle, data may be buffered.

In an example, exciting resonance frequencies of the railcar axle at 320 includes impacting the railcar axle. Impacting the railcar axle may be accomplished using a hammer. In another example, impacting the railcar axle may be accomplished by firing a projectile at the railcar axle with an air gun.

Alternative resonance excitation methods include direct excitation of the wheels. This excitation is transmitted to the axle and excites the resonances. Another alternative method is to excite the wheels using track irregularities. The resulting impulse excitation will be transmitted to the axle thereby exciting the axle resonances.

In an example, measuring the resonance frequencies of the railcar axle is performed with one or more no-contact vibration sensors and/or one or more acoustic sensors.

Example non-contact vibration sensors include laser Doppler vibrometers (LDV). Excitation response measurement is made immediately after the excitation. The axle is in the line of sight of the LDV laser beam, and adequate backscattered laser light will be available for about ¼ of the axle revolution. In an example, retroreflective coating of a part of the axle may improve measurements. The laser Doppler vibrometer may be maintained at a fixed orientation of the vibrometer while being focused on a substantially fixed location on the railcar axle while the railcar axle translates, for example, along a track.

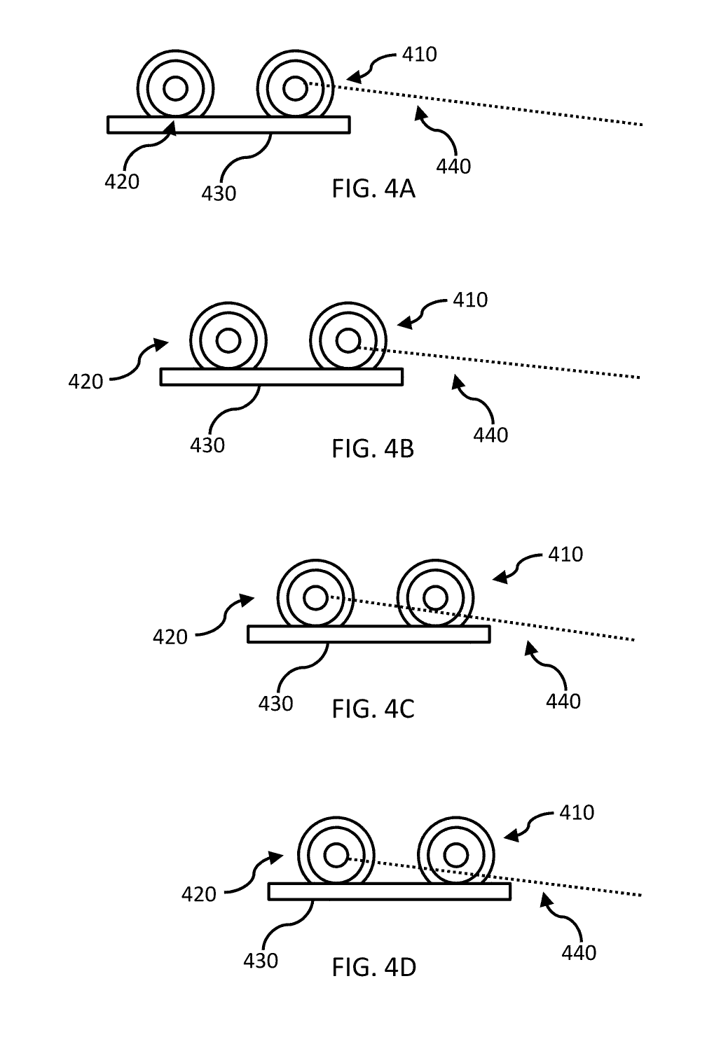

FIGS. 4A-4D illustrate phases of an example process of a laser Doppler vibrometer measuring the vibration response of both axles 410 and 420 of a two-axle bogie for a train moving on track 430. The orientation of the measurement beam 440 remains substantially constant. In this configuration, due to the combined effect of the axle translation and rotation, the translation of the laser spot relative to a point on the axle will be very small, thereby minimizing laser pseudo-noise due to speckle movement. In addition, this configuration enables illumination of all axles of a railcar with the laser without the possibility of an adjacent axle blocking the laser line of site.

Other example non-contact vibration sensors include photo-emf laser vibrometers which take advantage of the nonsteady-state photo-electromotive force (photo-emf) effect. Photo-emf laser vibrometers are not sensitive to surface motion enabling measurement of vibration of moving surfaces.

Example acoustic sensors suitable for measuring the vibration response of either moving or semi-static railcar axles include one or more microphones. In a further example, an array of microphones can be used to increase the ratio of signal to background noise by beamforming the array to a location on the axle.

Other example acoustic sensors suitable for measuring the vibration response of a moving or semi-static railcar axle include acoustic intensity sensors which, being directional, may increase the ratio of signal to background noise when oriented towards the axle. Example, acoustic intensity sensors include two microphone acoustic intensity sensors (p-p type) or sound pressure and the particle velocity sensors (p-u type)

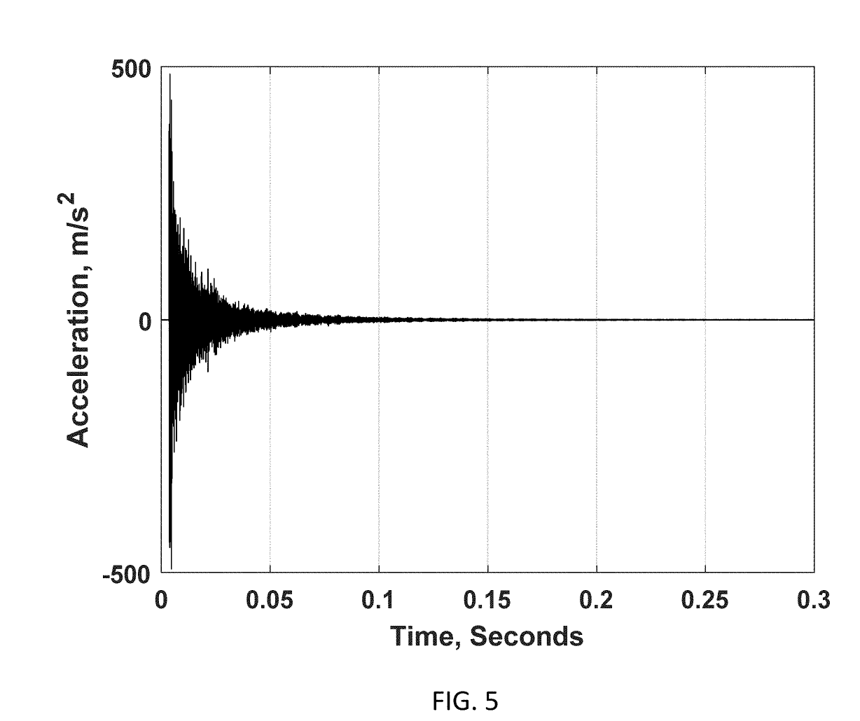

Selecting at least one resonance frequency from the measured resonance frequencies at 330 (FIG. 3) may include producing/obtaining a single FFT of the entire excitation response to obtain the spectral information from the time history. In an example, LDV output time history is sampled at a sampling speed sufficient to obtain 0-100 kHz spectral results. Impulse response data similar to that shown by way of example in FIG. 5 result.

For a moving railcar, if the axle is uncracked, the axle resonances will not change during the revolution so that the spectral result obtained will exhibit clearly defined resonances. On the other hand, if the axle is cracked, the axle resonance frequencies will oscillate between their uncracked axle values and their cracked axle values once per revolution. Consequently, a single FFT of the entire impulse response will not show clear resonances, but rather will show a smearing of these frequencies.

Resonance frequency shifting may be simulated using time compression of the impact response shown in FIG. 5 for a stationary, uncracked axle. The time axis for the uncracked axle corresponds to N evenly spaced time intervals and is given by:

t=[Δt₁,Δt₂,Δt₃, . . . Δt_{N}]

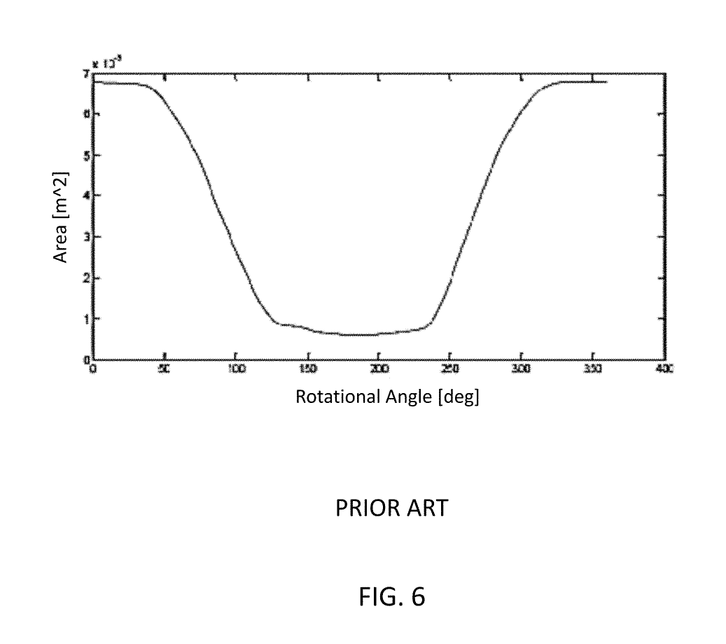

For the 250 kHz sampling rate Δt=1/250000. Crack breathing frequency shifting is assumed to be proportional to the area in contact between crack surfaces as a function of axle rotation. FIG. 6 shows reported results for a crack which is 35% of the axle cross section. This may be approximated using a cosine function. The time compression factor (timeCompFact) as a function of time is therefore given by:

$$TimeCompFact = ShiftFactor ( 1 - cos ( \frac{2 v}{D} t ) )$$

where v is the train speed in ft/s and D is the wheel diameter in ft and the Shift Factor is assumed to be 0.002 corresponding to crack related frequency shifts.

Using this formulation, a time compression factor is generated for each time interval:

\hat{t}=[\hat{t}₁,\hat{t}₂,\hat{t}₃. . . \hat{t}_{N}]

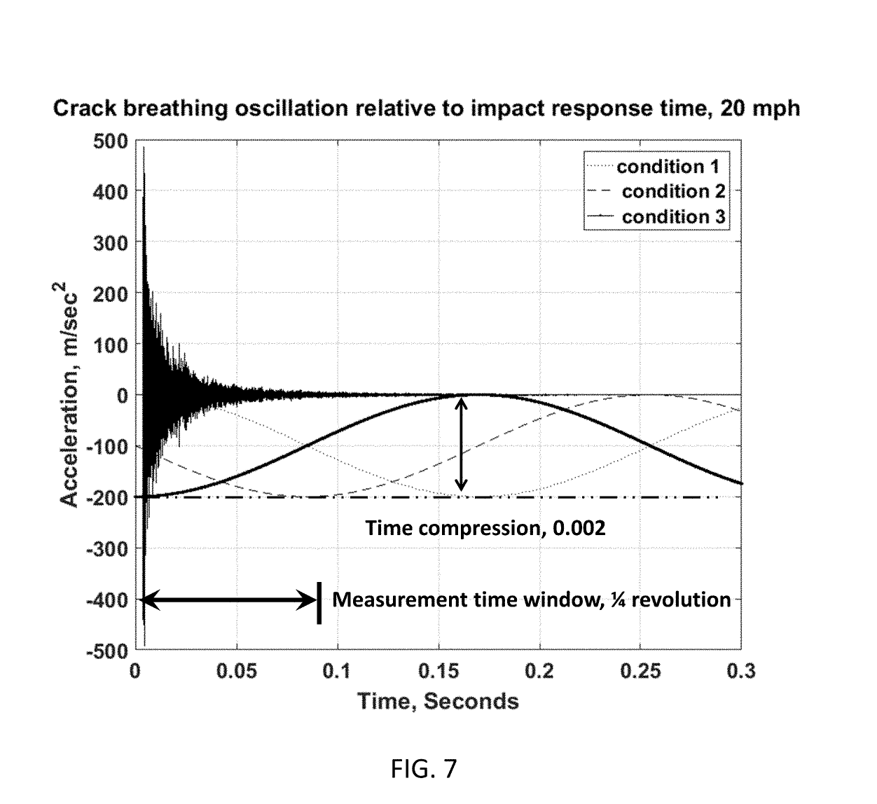

and added to each time interval, resulting in a time compressed time factor. The time history response for the uncracked axle is then interpolated to match this new abscissa. FIG. 7 illustrates, for a 20 mph train, the time history after the time compression along with the time compression factor for three initial conditions. Condition 1 corresponds to the case where the crack is completely closed at the time of impact (no frequency shift), condition 2 corresponds the axle rotated 90 degrees at the time of impact and condition 3, axle rotated 180 degrees, is the case where the crack is completely open at the time of impact (maximum frequency shift). Also shown is the measurement time window which is assumed to be ¼ of the axle rotation.

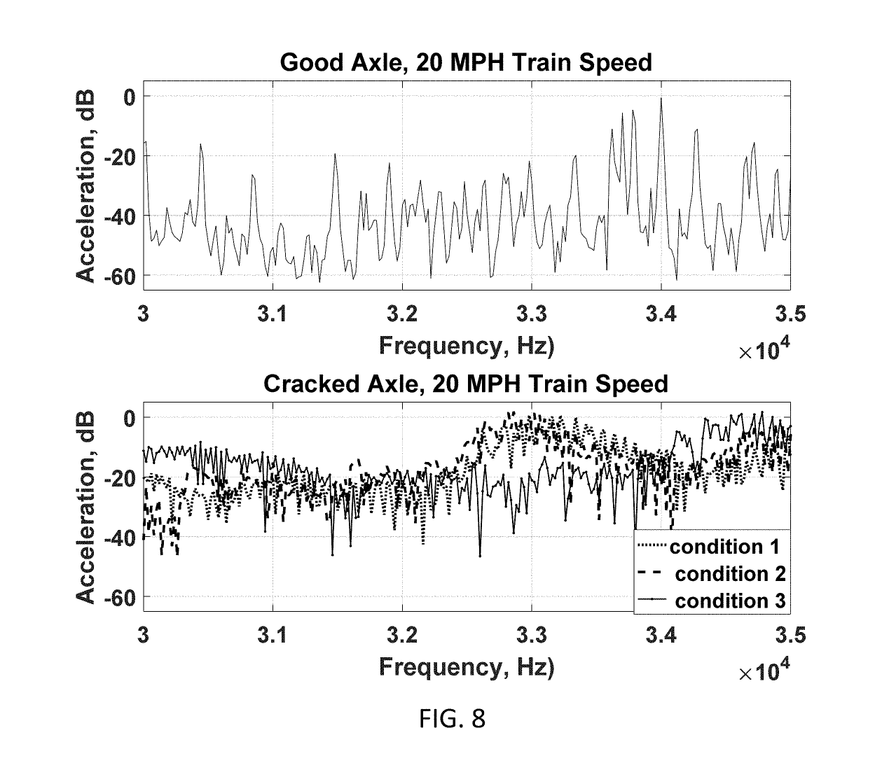

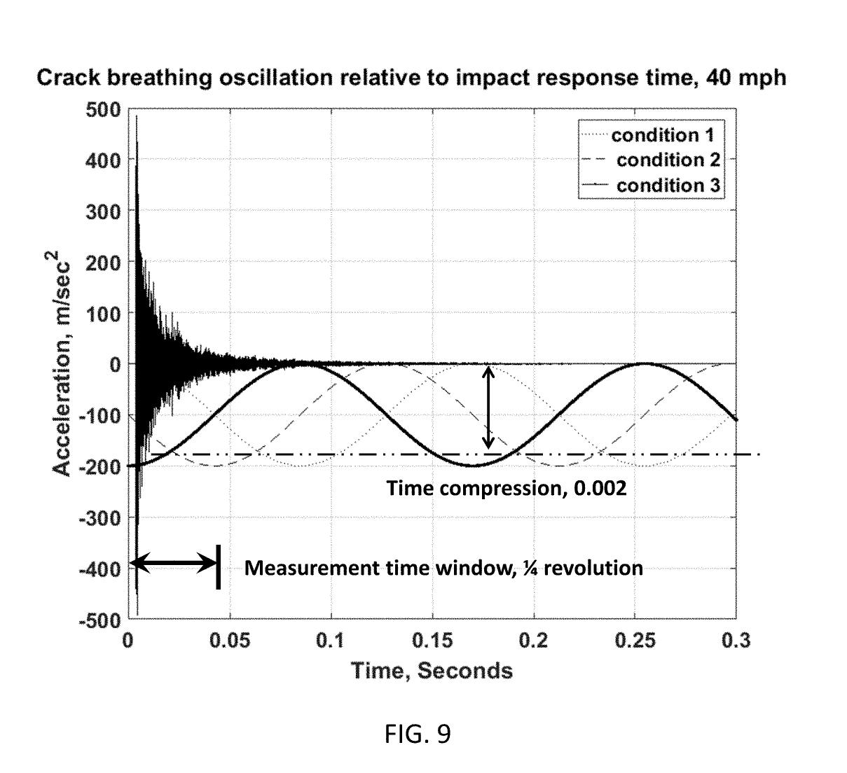

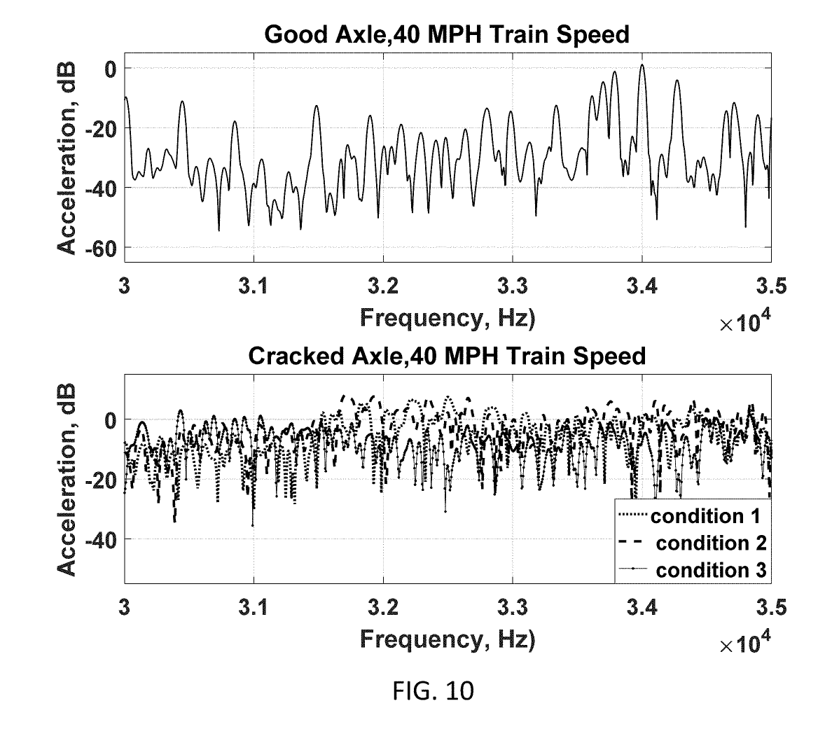

FIG. 8 illustrates the spectral response obtained with no time compression (a), and with time compression corresponding to the three initial conditions described above (b). The spectral results for the time compressed data differs significantly from the uncompressed, with the uncompressed showing clear and distinct axle resonance frequencies, while the time compressed shows a smearing of these resonances, as predicted. Similar results are shown in FIG. 9 and FIG. 10 for a 40 mph train.

Selecting at least one resonance frequency from the measured resonance frequencies at 330 (FIG. 3) may additionally and/or alternatively include performing time frequency analysis, producing a spectrogram, and/or producing a wavelet transform. The spectral information can be obtained from the time history using any suitable spectrogram or wavelet transform method.

Automatically determining whether the railcar axle is cracked includes determining, at 340, whether the at least one selected resonance frequency varies during the rotating and translating of the moving train mode. In an example, automatically determining whether the railcar axle is cracked includes comparing processed images and/or picking spectral peaks.

For a moving train, it is necessary to measure the axle impact response in the presence of the vibration due to rolling. To avoid false positive test results while a railcar is rolling, selecting at least one resonance frequency may further include selecting at least one frequency having a higher amplitude than both the amplitude of rolling noise and the amplitude of wheel resonance frequencies.

Rolling noise is known to be significant at frequencies less than about 5 kHz. Additionally, wheel resonances may be excited as a result of axle excitation. Wheel resonances are known to be significant at frequencies up to about 25 kHz.

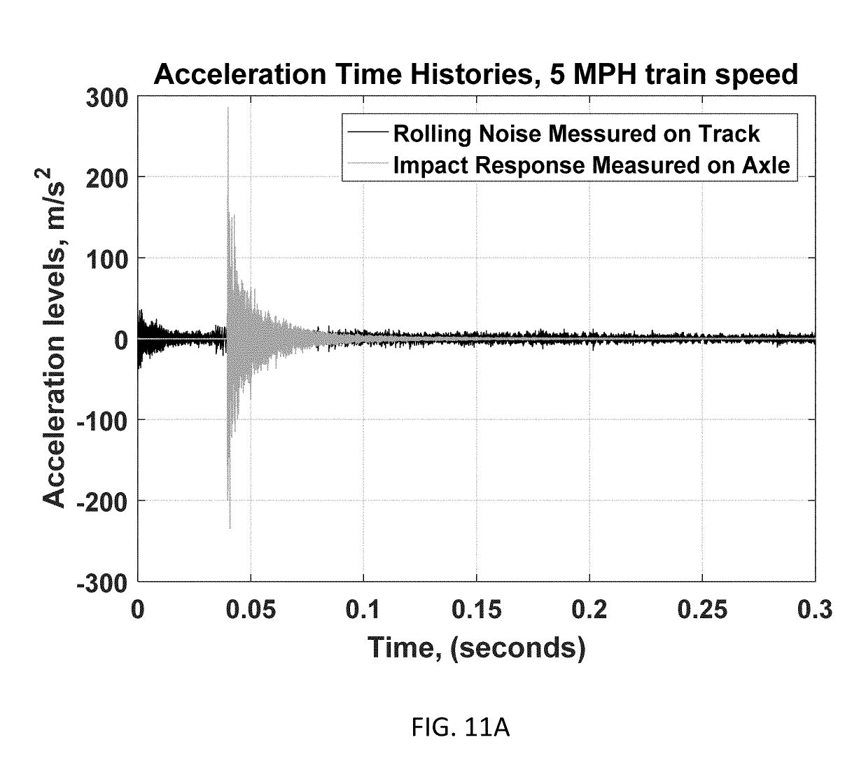

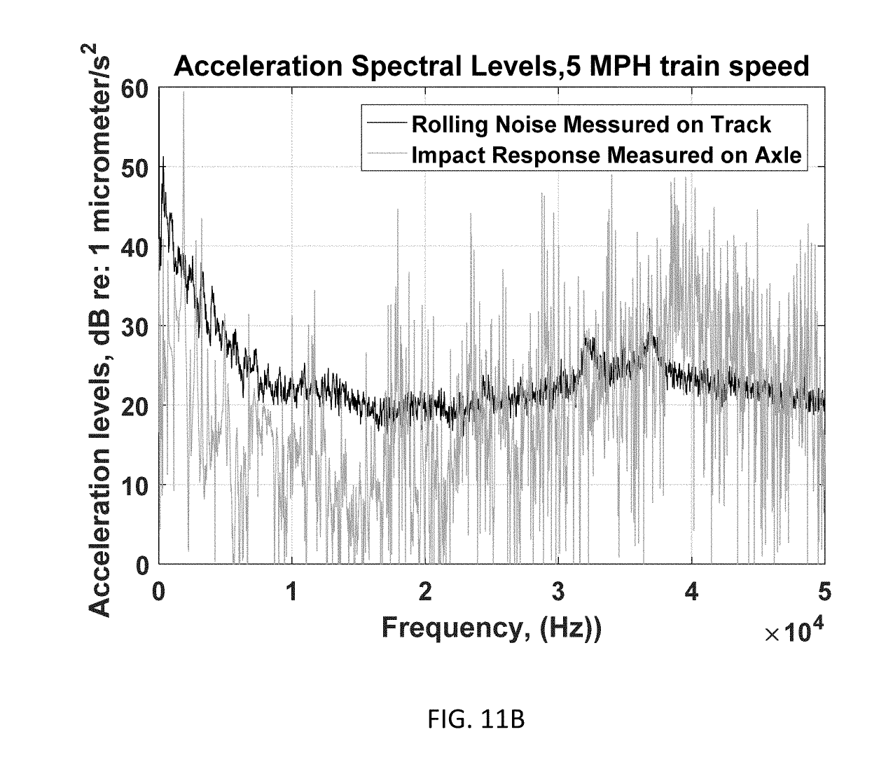

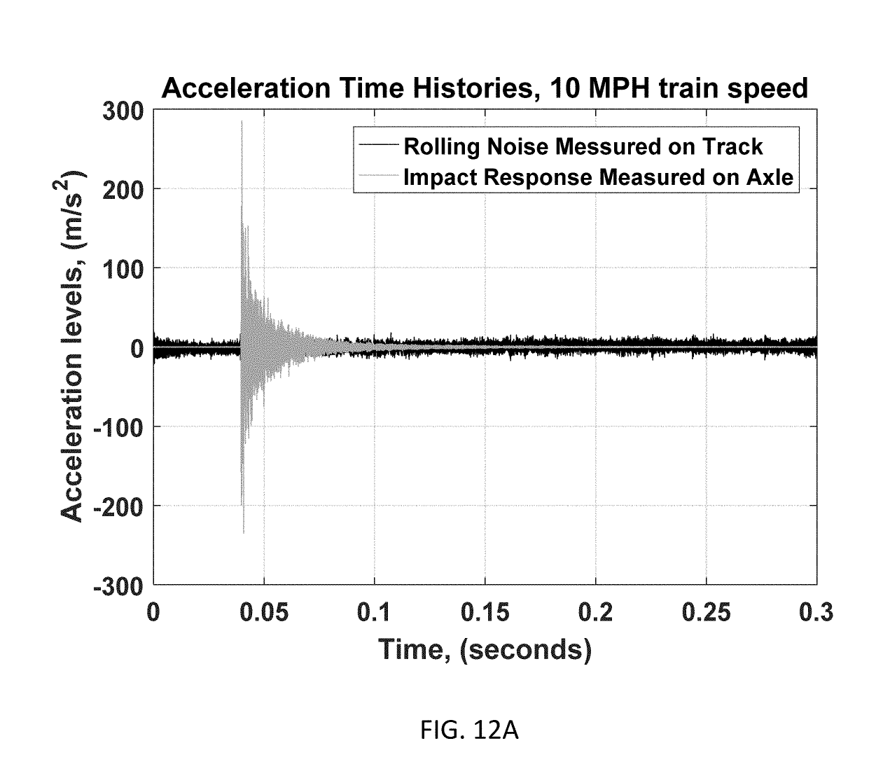

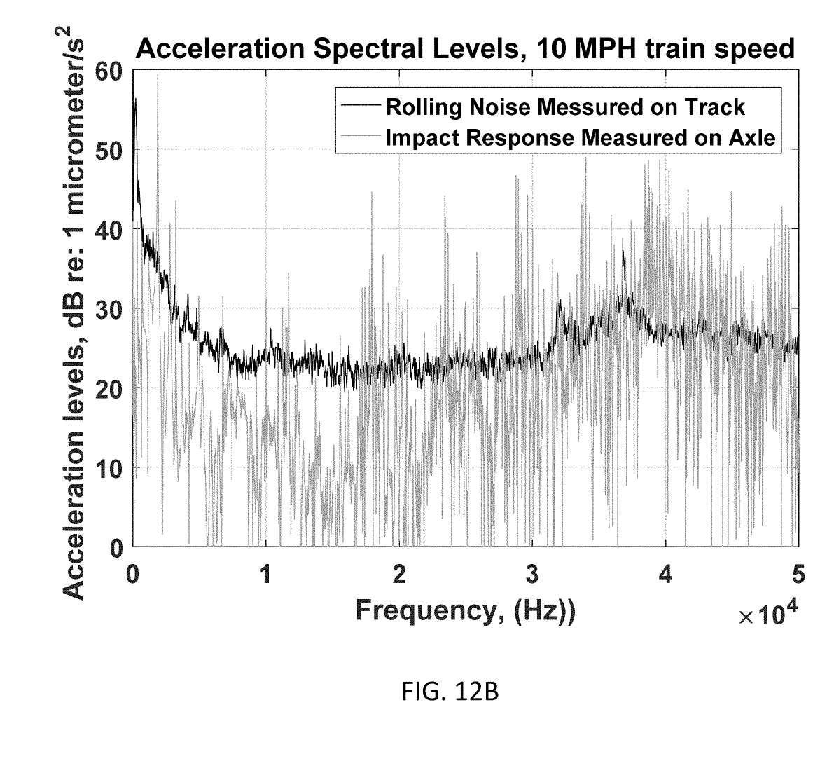

The relative level of rolling noise and axle impact response has been measured and is presented herein. FIG. 11A shows accelerometer response measured on a track for a 20 car consist moving at 5 mph, with the impact response acceleration for a stationary axle superimposed. The spectral results for each are illustrated in FIG. 11B where the rolling noise measured on the track is frequency dependent and decreases at about 30 dB per decade up to about 10 kHz. In contrast, the impact response measured on the axle does not decay with frequency and has many resonance peaks which exceed the track rolling noise by at least 20 dB for frequencies from 20 kHz to 50 kHz. A similar result is shown in FIG. 12A and FIG. 12B for a 10 mph train. It should be noted that FIG. 11 and FIG. 12 compare the rolling noise measured on the track to the axle response measured on the axle. In fact, the rolling vibration transmitted to the axle will be substantially less due to the vibration attenuation in this transmission process.

Therefore, in an example, selecting the at least one resonance frequency at 330 (FIG. 3) includes selecting a frequency greater than about 30 kHz or higher because at these frequencies, the vibration due to rolling is very low compared to the axle impact response and there is little chance of contamination of results from wheel resonances.

The actions 310 to 360 are only illustrative and other alternatives can also be provided where one or more actions are added, one or more actions are removed, or one or more actions are provided in a different sequence without departing from the scope of the claims herein.

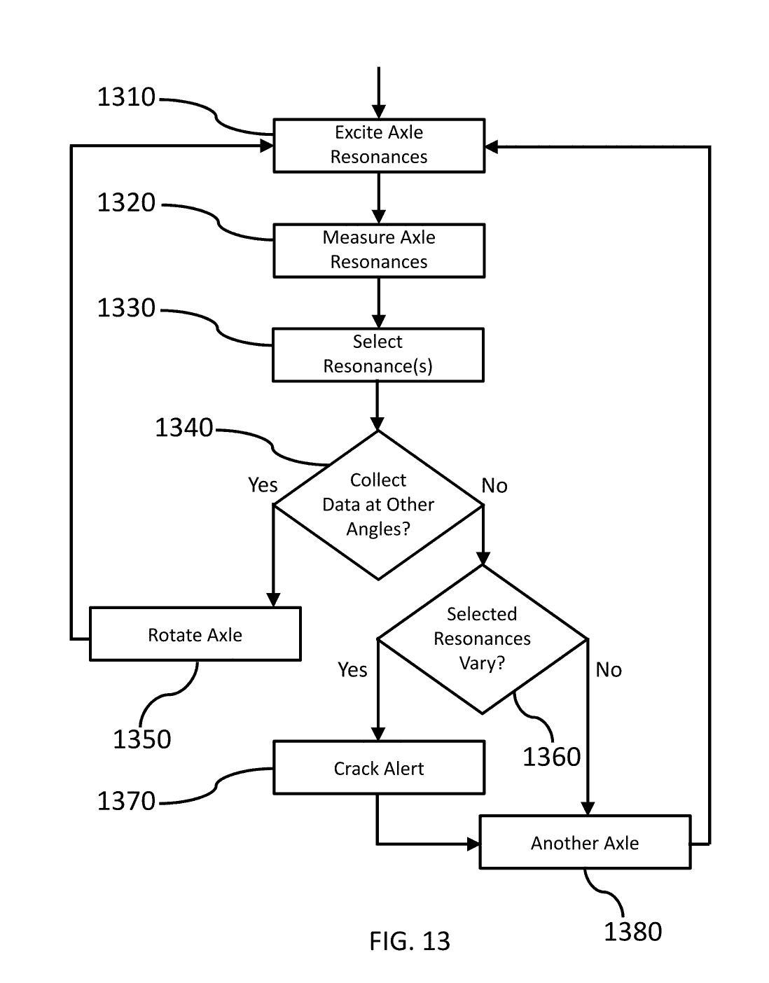

FIG. 13 illustrates a flow of another example method for railcar axle crack detection. Referring to FIG. 13, in a semi-static mode of operation exciting resonance frequencies of the railcar axle and measuring the excited frequencies are performed while the railcar axle is rotatably coupled with and loaded by a railcar but is neither translating nor rotating. For this mode of operation, the axle is excited at 1310 and the response measured at 1320 while the train is stationary.

With a static train and railcar axles neither translating nor rotating, resonance frequencies of the railcar axle may be excited by impacting the railcar axle with a handheld device. Additionally, resonance frequencies of the railcar axle may be measured with an accelerometer. In an example, an accelerometer may be coupled with the railcar axle.

At 1330, at least one resonance frequency is selected from the measured resonance frequencies. With at least a first measurement taken, if it is determined at 1340 that one or more additional measurements are to be taken for comparison, the exciting, the measuring and the selecting are repeated after rotating the railcar axle a major fraction of a complete rotation at 1350. The train moves a distance corresponding to a fraction of the wheel rotation such as ¼, ½ or ⅓ and the impact/response is repeated. This process is repeated a number of times so that if a crack is present, it will have the opportunity of opening and/or closing as a result of the wheelcar load and the changing axle rotation.

It may then be determined that the railcar axle is cracked at and an alert or notification issued at 1370 when the at least one selected resonance frequency is established at 1360 to be different after the repeating. Conversely, it may be determined the railcar axle is not cracked when the at least one selected resonance frequency is substantially the same after the repeating. Rotating the railcar axle followed by exciting, measuring and selecting may be repeated any number of times suitable to produce a desired level of confidence that there is no crack breathing. If there are more axles to be excited and measured, the method proceeds to a new axle at 1380 where the method restarts at 1310.

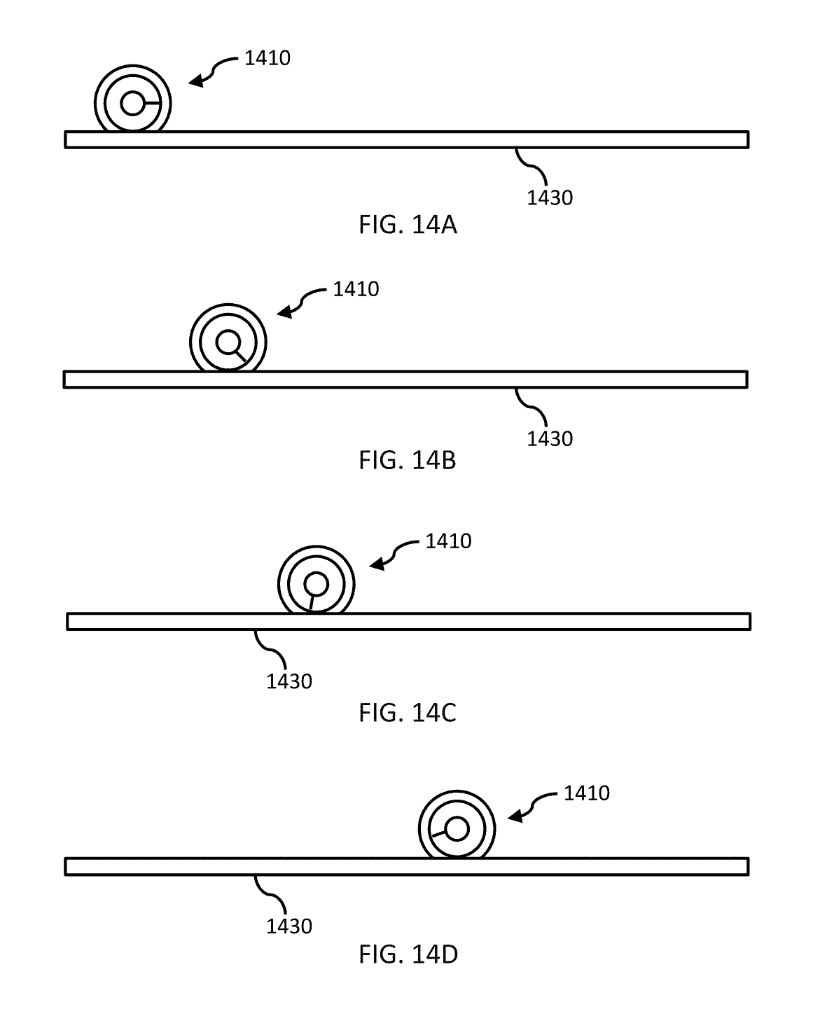

FIG. 14 illustrates various positions of a railcar axle during an example semi-static method for railcar axle crack detection. In FIG. 14A, an example railcar axle 1410 is shown in a starting position on rail 1430. In FIG. 14B, example railcar axle 1410 is shown in a second position on rail 1430 rotated between 45 and 90 degrees. In FIG. 14C, example railcar axle 1410 is shown in a third position on rail 1430 rotated an additional 30 to 60 degrees. In FIG. 14D, example railcar axle 1410 is shown in a fourth position on rail 1430 rotated an additional 20 to 30 degrees.

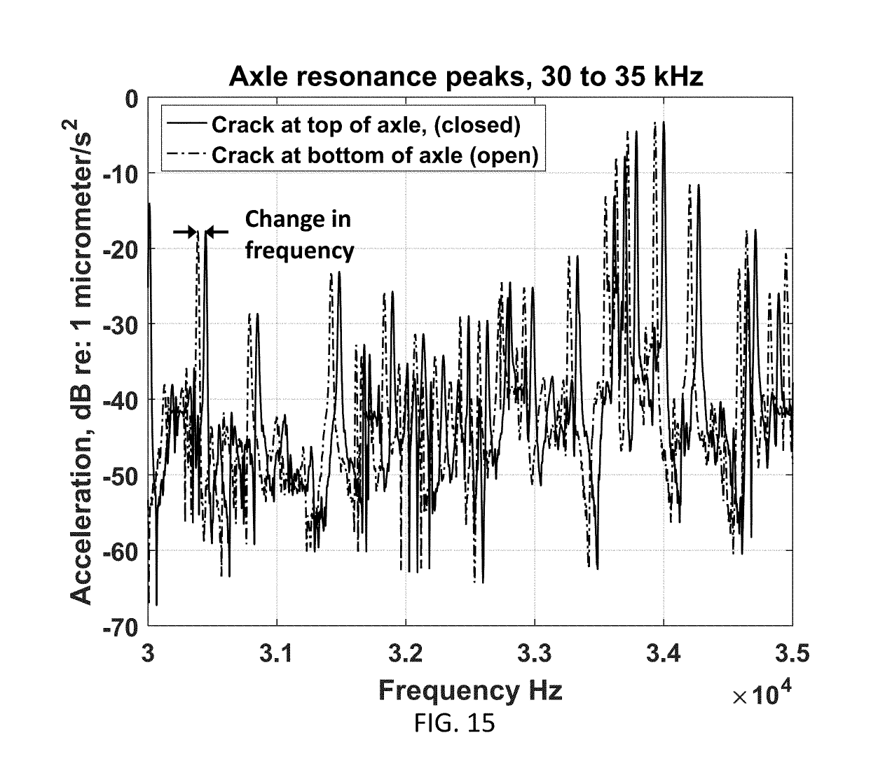

In the semi-static mode, the presence of a crack will result in a change in the axle resonance frequencies when the axle rotation is changed. A simulation of this was performed in a manner similar to that for the moving train mode, except that the time compression factor is linear. FIG. 15 shows results for this simulation, again assuming a 0.2% shift in frequency due to crack breathing.

The actions 1310 to 1380 are only illustrative and other alternatives can also be provided where one or more actions are added, one or more actions are removed, or one or more actions are provided in a different sequence without departing from the scope of the claims herein.

A system for railcar axle crack detection detects crack breathing in accordance with methods described above. The system includes means for exciting resonance frequencies of a railcar axle, means for measuring the resonance frequencies of the railcar axle and computing hardware.

Means for exciting resonance frequencies of the railcar axle may include means for impacting the railcar axle. In an example, the impacting means may include a hammer which may be rotated from a position perpendicular to the railcar axle and parallel with the direction of translation of the railcar axle to a position perpendicular to the rail car axle but at an angle to the direction of translation of the railcar axle. Alternatively stated, the hammer is rotated from horizontal to a position with the head suitably elevated to strike the railcar axle. The hammer employed for exciting resonance frequencies is configured to excite resonance frequencies while the railcar axle is rotating and translating.

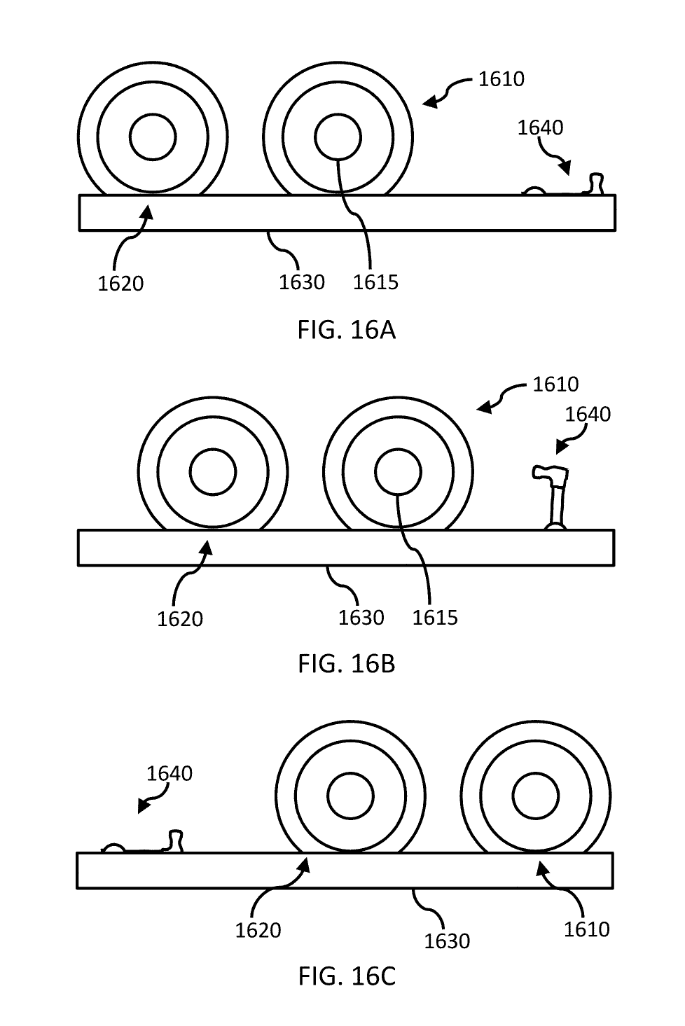

FIGS. 16A-C illustrate an example impact hammer 1640 in use to impact wheelset axles 1610 and 1620 as a train traverses a measurement location. Hammer 1640 may be rotated about a horizontal axis from a horizontal orientation (FIG. 16A) to an orientation (FIG. 16B) angled relative to horizontal such that a head of the hammer is elevated to a height at which the head may strike the railcar axle. After the wheelset has passed the measurement location, (FIG. 16C), hammer 1640 may be returned to the horizontal orientation. In a further example, a biasing member and/or restoring member such as a spring it coupled with hammer 1640 such that will yield to impact with/by a railcar axle.

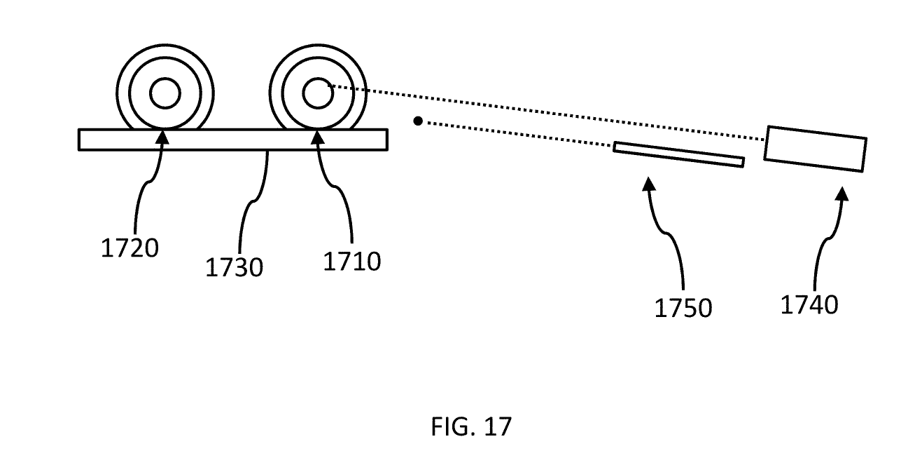

In other examples, the impacting may be performed by a projectile and means for propelling a projectile. For example, a projectile such as a ball or pellet may be fired with an air gun. The projectile and air gun employed for exciting resonance frequencies are configured to excite resonance frequencies while the railcar axle is rotating and translating. FIG. 17 illustrates a projectile impact mechanism 1750 for direct excitation of axles 1710 and 1720 of a train travelling on track 1730.

As set forth above, additionally or alternatively, excitation may be accomplished by directly exciting wheels of the railcar axle and/or indirectly exciting the wheels. Direct excitation of the wheels may include, for example, exciting the wheels using track irregularities.

Means for measuring the resonance frequencies of the railcar axle may include a no-contact vibration sensor or acoustic sensor. In an example, the means for measuring the resonance frequencies of the railcar axle includes a vibrometer configured to focus on a substantially fixed location on the railcar axle during translation of the railcar axle. Other example means for measuring the resonance frequencies of the railcar axle include a photo-emf laser vibrometer, at least one microphone, an array of microphones and a sound intensity probe. The means for measuring the resonance frequencies of the railcar axle is configured to measure resonance frequencies while the railcar axle is rotating and translating.

FIG. 17 also illustrates the example projectile impact mechanism 1750 in use with an example collocated laser Doppler vibrometer measurement system 1740. The laser Doppler vibrometer may be maintained at a fixed orientation while being focused on a substantially fixed location on the railcar axle 1710 while the railcar axle translates, for example, along a rail 1730. Continued translation of axle 1710 and the associated railcar positions axle 1720 for excitation by projectile impact mechanism 1750 and measurement by vibrometer 1740.

The fixed orientation may depend, in part, upon the spacing between railcar axles. In an example, a laser Doppler vibrometer used for measurement may be maintained at an orientation of less than about 10 degrees to horizontal. In a further example, a laser Doppler vibrometer used for measurement may be maintained at an orientation of about 7 degrees to horizontal.

An alternative system for railcar axle crack detection includes means for exciting resonance frequencies while the railcar axle is neither translating nor rotating and the means for measuring the resonance frequencies of the railcar axle is configured to measure resonance frequencies while the railcar axle is neither translating nor rotating. In an example, the means for exciting resonance frequencies is configured to excite resonance frequencies while the railcar axle is rotatably coupled with and loaded by a railcar and the means for measuring the resonance frequencies of the railcar axle is configured to measure resonance frequencies while the railcar axle is rotatably coupled with a railcar.

Means for exciting resonance frequencies of the railcar axle while the railcar axle is neither translating nor rotating, may include a handheld device and means for measuring the resonance frequencies of the railcar axle may include an accelerometer coupled with the railcar axle. In an example, an accelerometer attached to a railcar axle simply using an adhesive.

Alternatively, means for exciting resonance frequencies of railcar axles and means for measuring resonance frequencies while the railcar axle is neither translating nor rotating may include any of those disclosed for use with a system configured to detect railcar axle cracks in translating and rotating axles.

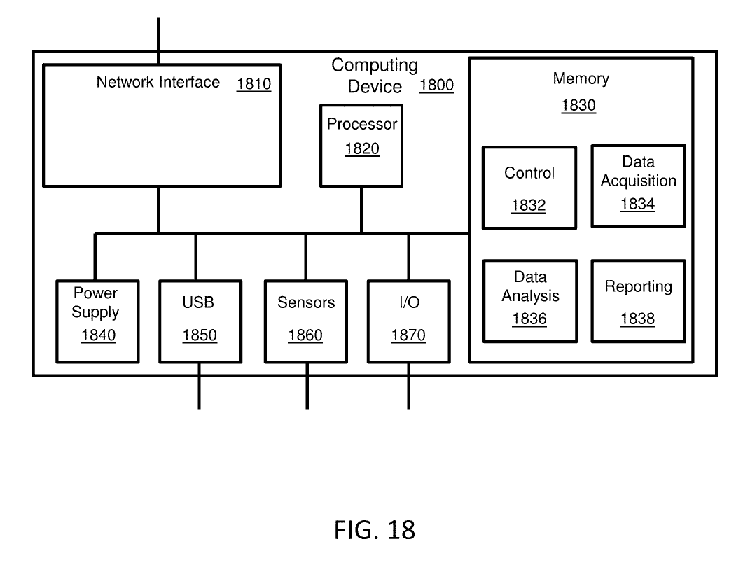

FIG. 18 schematically illustrates various components of a computing device 1800, suitable for use with disclosed systems and methods for cracked axle detection. Computing device 1800 may include, but is not limited to, a memory 1830, computing hardware such as a processor 1820, Input/Output (I/O) devices 1870, a network interface 1810, a universal serial bus connection 1850 and a configuration of sensors 1860 operatively coupled together. I/O devices 1870 may include a display screen for presenting graphical images to a user of computing device 1800.

Computing device 1800 also includes a power source 1840 for supplying electrical power to the various components thereof. The power source may, for example, include a rechargeable battery or may take advantage of solar power.

Memory 1830 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

Memory 1830 stores various modules arranged to cause computing device 1800 and associated components to perform one or more actions of disclosed methods for railcar axle crack detection. In an example, a control module 1832 may be configured to operate one or more means for exciting resonance frequencies of a railcar axle. In an example, a data acquisition module 1834 may be configured to operate one or more means for measuring resonance frequencies of the railcar axle. In an example, a data analysis module 1836 may be configured to select resonance frequencies and automatically determine whether the railcar axle is cracked. In an example, a reporting module 1838 may be configured to output results of analysis by the data analysis module to a user. Output may include but is not limited to graphics for presentation to a display, audio or hardcopy output such as a print-out and effectively communicates a crack alert as referred to in FIGS. 3 and/or 13.

Control module 1832, a data acquisition module 1834, a data analysis module 1836 and reporting module 1838 may, for example, be parts of a software product associated with a cracked axle detection service. Executing the software product on processor 1820 results in generating and rendering a graphical user interface on the display screen. The graphical user interface is configured to facilitate user interactions with the cracked axle detection service.

In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a pen.

Additionally or alternatively, I/O devices 1870 include a mouse or a joystick that is operable to receive inputs corresponding to clicking, pointing, and/or moving a pointer object on the graphical user interface. I/O devices 1870 may also include a keyboard that is operable to receive inputs corresponding to pushing certain buttons on the keyboard. Additionally, I/O devices 1870 may also include a microphone for receiving an audio input from the user, and a speaker for providing an audio output to the user.

Moreover, sensors 1860 may include one or more of: an accelerometer, a magnetometer, a pressure sensor, a temperature sensor, a gyroscopic sensor, a Global Positioning System (GPS) sensor, a Doppler laser vibrometer, a photo-emf laser vibrometer, at least one microphone, an array of microphones and a sound intensity probe or a timer. Sensors 1860 may be used to measure and collect data related to surroundings of the user or those of a railcar axle or a cracked axle measurement location. Sensors 1860 may further be used to measure and collect data related to railcar axle resonances, railcar axle resonance frequencies, railcar axle crack breathing and/or area in contact between crack surfaces in a railcar axle. Similarly, outputs generated by sensors 1860 may, for example, be indicative of railcar axle resonances, railcar axle resonance frequencies, presence of railcar axle cracks, railcar axle crack breathing and/or area in contact between crack surfaces in a railcar axle.

In some examples, the software product may be interfaced with sensors 1860. When executed on processor 1820, the software product, and, in particular, data acquisition module 1834 is configured to resolve and integrate outputs of the sensors 1860 into useful information about at least one of presence of railcar axle cracks, railcar axle crack breathing and/or area in contact between crack surfaces in a railcar axle.

In some examples, sensors 1860 may include a timer for including time-stamps with data measured and collected relating to railcar axle resonances, railcar axle crack breathing and/or area in contact between crack surfaces in a railcar axle. Alternatively, processor 1820 may provide system time as reference for including the time-stamps with this data.

Moreover, memory 1830 is a non-transient data storage medium. The software product, when executed on processor 1820, is optionally configured to substantially continuously record and update measured and collected data in memory 1830.

Furthermore, the network interface 1810 optionally enables computing device 1800 to upload measured and collected data to a server, for example, via a communication network. Additionally, network interface 1810 may allow computing device 1800 to access the server to update the software product and/or download one or more new software products associated with the cracked axle detection service.

Moreover, network interface 1810 optionally allows computing device 1800 to communicate with other computing devices, for example, via a communication network.

Computing device 1800 is optionally implemented by way of at least one of: a mobile phone, a smart telephone, an MID, a tablet computer, a UMPC, a phablet computer, a PDA, a web pad, a PC, a handheld PC, a laptop computer, a desktop computer, an NAS device, a large-sized touch screen with an embedded PC, and an interactive entertainment device, such as a game console, a TV set and an STB.

Upon execution of instructions and/or programming of the software and associated modules 1832, 1834, 1836 and 1838, computing device 1800 is configured to perform the actions of the methods as described above in conjunction with FIGS. 3, 4, 13 & 14.

Computing device 1800, for example, in particular processor 1820, is configured to select at least one resonance frequency from resonance frequencies measured by one or more of sensors 1860 and automatically determine whether the railcar axle is cracked from the at least one identified resonance frequency by detecting crack breathing.

For example, computing device 1800 and/or processor 1820 may be configured to select at least one resonance frequency from measured resonance frequencies by, in part, producing a single FFT of the entire impact response, performing time frequency analysis, producing a spectrogram or producing a wavelet transform.

Computing device 1800 and/or processor 1820 may be further configured to pick spectral peaks as part of the crack evaluation process. In a further example, determining, with computing device 1800 and/or processor 1820, whether the railcar axle is cracked may further include comparing processed images.

In an example, in order to avoid false positive test results while a railcar is rolling, computing device 1800 and/or processor 1820 are configured to select at least one frequency having an amplitude higher than both the amplitude of rolling noise and the amplitude of wheel resonance frequencies. For example, computing device 1800 may select a frequency greater than about 30 kHz.

In an example, computing device 1800 and/or processor 1820 are configured to determine whether the railcar axle is cracked by determining whether at least one identified resonance frequency varies during rotating and translating of the railcar axle.

In another example, computing device 1800 and/or processor 1820 may be configured to automatically determine whether the railcar axle is cracked by comparing resonance frequencies identified after excitation and measurement at various rotational angles of the railcar axle such as with static mode tests. For example, computing device 1800 may automatically determine the railcar axle is cracked when resonance frequencies measured at various rotational angles of the railcar axle are different when compared.

Greater differences between resonance frequencies suggest greater crack sizes. The threshold beyond which a railcar axle is considered cracked may vary with the intended use of the railcar axle. For example, if a rail car axle is intended for use with a passenger train, a more conservative threshold may be established such that a smaller difference between frequencies, implying a smaller crack size, determines a cracked railcar axle. In an example, when the frequency difference is equal to or greater than 0.2%, the railcar axle is determined to be cracked.

Computing device 1800 is configured to automatically determine the railcar axle is not cracked when the compared resonance frequencies are substantially the same. For example, when the frequency difference is less than 0.2%, the railcar axle is determined to be uncracked.

FIG. 18 is merely an example, which should not unduly limit the scope of the claims herein. It is to be understood that the specific designation for computing device 1800 is provided as an example and is not to be construed as limiting computing device 1800 to specific numbers, types, or arrangements of modules and/or components. A person skilled in the art will recognize many variations, alternatives, and modifications of embodiments of the present disclosure.

As suggested above, network interface 1810 optionally allows computing device 1800 to upload measured and collected data, download one or more software products, and/or communicate with one or more other computing devices via a communication network.

In an example, such a communication network associated with one or more computing devices, a server and a database associated with the server may be part of a network environment suitable for practicing embodiments of the present disclosure.

The network environment may be implemented in various ways, depending on various possible scenarios. In one example scenario, the network environment may be implemented by way of a spatially collocated arrangement of the server and the database. In another example scenario, the network environment may be implemented by way of a spatially distributed arrangement of the server and the database coupled mutually in communication via the communication network. In yet another example scenario, the server and the database may be implemented via cloud computing services.

The computing devices are coupled in communication with the server via the communication network. The communication network can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

In an example, the computing devices and/or the server record and update changes in the status of the measured and collected data in the database.

The described network environment is merely an example, which should not unduly limit the scope of the claims herein. It is to be understood that the specific designation for the network environment is provided as an example and is not to be construed as limiting the network environment to specific numbers, types, or arrangements of computing devices, servers, databases and communication networks. A person skilled in the art will recognize many variations, alternatives, and modifications of embodiments of the present disclosure.

Embodiments of the present disclosure provide a computer program product that includes a non-transitory or non-transient computer-readable storage medium storing computer-executable code for an axle crack detection service. The code, when executed, is configured to perform the actions 310 to 360 and 1310 to 1380 of the methods as described in conjunction with FIGS. 3, 4, 13 & 14. As actions of the disclosed methods may be provided in different sequences, so the computer-executable code may be configured to provide a service having a different sequence of actions from those illustrated in FIGS. 3, 4, 13 & 14. In some examples, the code may be loaded into a computer memory from a non-transitory computer-readable medium. In other examples, the code may be downloaded from a software application store, for example, from an “App store”, to a data processing unit or computing device.

Embodiments of the present disclosure are susceptible to being used for various purposes, including, though not limited to, enabling users to determine whether an axle is cracked.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A method for railcar axle crack detection, comprising:
exciting resonance frequencies of a railcar axle;
measuring the excited resonance frequencies of the railcar axle;
selecting at least one resonance frequency from the measured resonance frequencies; and
automatically determining whether the railcar axle is cracked from the at least one selected resonance frequency.

2. The method as set forth in claim 1, wherein automatically determining whether the railcar axle is cracked further comprises detecting crack breathing.

3. The method as set forth in claim 1, wherein selecting at least one resonance frequency further comprises selecting at least one frequency having a higher amplitude than both the amplitude of rolling noise and the amplitude of wheel resonance frequencies.

4. The method as set forth in claim 1, wherein exciting resonance frequencies of the railcar axle further comprises impacting the railcar axle.

5. The method as set forth in claim 1, wherein measuring the resonance frequencies of the railcar axle further comprises measuring with a no-contact vibration sensor or acoustic sensor.

6. The method as set forth in claim 1, wherein the exciting and the measuring are performed while the railcar axle is rotating and translating.

7. The method as set forth in claim 6, wherein automatically determining whether the railcar axle is cracked further comprises determining whether the at least one selected resonance frequency varies during the rotating and translating.

8. The method as set forth in claim 1, wherein the exciting and the measuring are performed while the railcar axle is neither translating nor rotating.

9. The method as set forth in claim 1, further comprising:
repeating the exciting, the measuring and the selecting after rotating the railcar axle a major fraction of a complete rotation; and
determining the railcar axle is cracked when the at least one selected resonance frequency is different after the repeating.

10. A system for railcar axle crack detection, comprising:
means for exciting resonance frequencies of a railcar axle;
means for measuring the excited resonance frequencies of the railcar axle; and
computing hardware configured to:
select at least one resonance frequency from the measured resonance frequencies; and
automatically determine whether the railcar axle is cracked from the at least one identified resonance frequency.

11. The system as set forth in claim 10, wherein the computing hardware is further configured to detect crack breathing.

12. The system as set forth in claim 10, wherein the computing hardware is configured to select at least one frequency having an amplitude higher than both the amplitude of rolling noise and the amplitude of wheel resonance frequencies.

13. The system as set forth in claim 10, wherein the means for exciting resonance frequencies of the railcar axle further comprises means for impacting the railcar axle.

14. The system as set forth in claim 10, wherein the means for measuring the resonance frequencies of the railcar axle further comprise a no-contact vibration sensor or acoustic sensor.

15. The system as set forth in claim 10, wherein the means for measuring the resonance frequencies of the railcar axle further comprise a vibrometer configured to focus on a substantially fixed location on the railcar axle during translation of the railcar axle.

16. The system as set forth in claim 10, wherein the means for exciting resonance frequencies is configured to excite resonance frequencies while the railcar axle is rotating and translating and the means for measuring the resonance frequencies of the railcar axle is configured to measure resonance frequencies while the railcar axle is rotating and translating.

17. The system as set forth in claim 16, wherein the computing hardware is further configured to determine whether at least one identified resonance frequency varies during the rotating and translating.

18. The system as set forth in claim 10, the means for exciting resonance frequencies is configured to excite resonance frequencies while the railcar axle is neither translating nor rotating and the means for measuring the resonance frequencies of the railcar axle is configured to measure resonance frequencies while the railcar axle is neither translating nor rotating.

19. The system as set forth in claim 18, wherein the computing hardware is configured to automatically determine whether the railcar axle is cracked by comparing resonance frequencies identified after excitation and measurement at various rotational angles of the railcar axle.

20. The system as set forth in claim 19, wherein the computing hardware is configured to automatically determine whether the railcar axle is cracked by determining that the railcar axle is cracked when the compared resonance frequencies are different.
